(19) United States
(12) Patent Application Publication
(10) Pub. No.: US 2015/0160788 A1
(43) Pub. Date: Jun. 11, 2015

(54) APPARATUS AND ASSOCIATED METHODS

(71) Applicants: Xiaowen Sun, Beijing (CN); Wei Wang, Beijing (CN); Yuezhong Tang, Beijing (CN); Bin Wang, Shanghai (CN)

(72) Inventors: Xiaowen Sun, Beijing (CN); Wei Wang, Beijing (CN); Yuezhong Tang, Beijing (CN); Bin Wang, Shanghai (CN)

(73) Assignee: Nokia Corporaiton, Espoo (FI)

(21) Appl. No.: 14/381,307

(22) PCT Filed: Feb. 27, 2012
(86) PCT No.: PCT/CN2012/071668

§ 371 Date: Feb. 23, 2015

(51) Int. Cl. G06F 3/0481; G06F 3/0484

(52) U.S. Cl. CPC G06F 3/0481; G06F 3/04842

(57) ABSTRACT

An apparatus comprising: at least one processor; and at least one memory including computer program code, the at least one memory and the computer program code configured to, with the at least one processor, cause the apparatus to perform at least the following: provide for first and second operational modes for a set of a plurality of user interface elements, the plurality of user interface elements in the set being associated with respective applications, wherein in the first operational mode, the set of the plurality of user interface elements is displayed such that limited contextual content is provided, the limited contextual content being associated with the respective applications and in the second operational mode, the set of the plurality of user interface elements is displayed such that additional contextual content Is provided, the additional contextual content being associated with the respective applications.

### TECHNICAL FIELD

The present disclosure relates to the field of user interfaces, associated methods, computer programs and apparatus. Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs), mobile telephones, smartphones and other smart devices, and tablet PCs.

The portable electronic devices/apparatus according to one or more disclosed aspects/embodiments may provide one or more audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Portable electronic devices may be configured to allow several applications to be run on the device. In some such devices, each application may be accessed by a user from a home screen. The home screen may display different user interface elements corresponding to the different applications available. The user interface element may be, for example, an icon, and may display the name of the associated application and/or a symbol indicating the associated application. Other user Interface elements may display information such as an indication of content relating to an associated application.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect there is provided an apparatus comprising at least one processor; and at least one memory including computer program code, the at least one memory and the computer program code configured to, with the at least one processor, cause the apparatus to perform at least the following: provide for first and second operational modes for a set of a plurality of user interface elements, the plurality of user interface elements in the set being associated with respective applications, wherein in the first operational mode, the set of the plurality of user interface elements is displayed such that limited contextual content is provided, the limited contextual content being associated with the respective applications and, in the second operational mode, the set of the plurality of user interface elements is displayed such that additional contextual content is provided, the additional contextual content being associated with the respective applications.

The provision for the first and second operational modes may be considered to at least provide for appropriate signalling to provide for the respective operational modes. For example, consider the case where the apparatus is not a portable electronic device, but is a sub-assembly of the device e.g. not comprising a display on which the first and second operational modes would be viewed/displayed. Of course, the apparatus may be configured to provide for the first and second operational modes by providing the operational modes on a display of a portable electronic device such that the user can interact with the device.

The additional contextual content provided in the second operational mode may be additional with respect to the limited contextual content provided in the first operational mode. Contextual content may comprise one or more of e-mail content, photographic content, image content, message content, notifications, social media content, RSS feed content, contact details, audio content, and a notification indicator. Contextual content may be considered contextual in that the content relates to the particular application with which the user interface element displaying contextual content is associated. For example, contextual content in relation to an e-mail application may include details of the content of e-mails received by contacts, the name of the contacts who sent the e-malls, and/or the time/date when the e-mails were sent. Contextual content in relation to a photo gallery application may include photographic images to be displayed in the photo gallery application. Contextual content may also refer to an indicator displaying, for example, the number of unread messages in a messaging application, since the indicator content may be understood as indicating the number of unread messages in the context of the messaging application.

The content may also be considered contextual if it relates to the user of a personal portable electronic device. For example, a user having a smartphone may have access to applications, and to content within those applications, which is personal to them. Therefore photographs may comprise contextual content of a personal nature if they contain images of the user, the user's family and friends, and locations which the user has photographed. A social media user interface element may comprise contextual content if, for example, the user interface element displays details of the user's contacts such as their names, locations, status updates, and posted comments.

The apparatus may be configured such that the plurality of user interface elements in the set may be associated with the actuation of respective applications. That is, a user may be able to interact with a user interface element and access functionality of that application. For example, tapping an icon for “amazon.com” may cause the apparatus to open an internet browser displaying the Amazon.com website.

The apparatus may be configured to move between the first and second operational modes by the provision of a single user identification for the set of the plurality of user interface elements. The single user identification may comprise one or more of a passcode, a PIN number, a shape traced on the apparatus, a fingerprint, a facial image, an iris image, and a particular user gesture. That is, the user may be able to provide a single user identification/password to the apparatus and thereby move from the first to the second operational mode. In doing so, the user may gain access to additional contextual content and/or functionality of the applications associated with the plurality of user interface elements in the set.

The apparatus may be configured such that the provision of one user identification/password may cause the user to be able to access additional contextual content for several (a plurality of) user interface elements. Thus each user interface element does not necessarily have an individual password associated with it; rather, the apparatus may be configured for password protection of a group/set of user interface elements.

The apparatus may be configured such that the set of the plurality of user interface elements may be provided on a discrete defined area of a display of the apparatus. The plurality of user interface elements in the set may be displayed on a display of the apparatus in a portion reserved for the display of the set of user interface elements. For example, the bottom portion of a display may be defined as a discrete defined area which can display the set of the plurality of user interface elements.

The apparatus may be configured such that the set of the plurality of user interface elements may represent a sub-set of the plurality of user interface elements available to a user on a particular home screen of the apparatus. For example, the bottom portion of a display of the apparatus may display the set of the plurality of user Interface elements, which is a sub-set of the plurality of user interface elements available on a home screen of the apparatus. The upper portion may display the other user interface elements outside that sub-set. Thus other user interface elements may be available which do not form part of the sub-set of the plurality of user interface elements.

The apparatus may be configured such that the user interface elements outside the sub-set of the plurality of user interface elements may provide the same level of contextual content in the first operational mode as in the second operational mode. That is, an icon which is not in the sub-set of the plurality of user interface elements may appear in the same way, and provide the same level of contextual content, whether the apparatus is operating in the first or the second operational mode.

The apparatus may be configured such that the set of the plurality of user interface elements is displayed in the same area of the display as other user interface elements outside the set. The apparatus may, for example, be configured such that the set of the plurality of user interface elements and other user interface elements outside that set are displayed with no demarcation which would otherwise indicate which user interface elements form part of the set of the plurality of user interface elements and which user interface elements do not form part of that set. That is, the plurality of user interface elements in the set may be displayed in the same regions/area of a display as user interface elements outside the set, with no particular demarcation, indication or boundary which may otherwise signify which user interface elements form part of the set.

For example, a group of user interface elements, both within and outside the set of the plurality of user interface elements, may be displayed in the same region of a display, such as on a common desktop or home screen. In this example there would be no indication or demarcation displayed as to which of the user interface elements formed part of the set and which user interface elements were outside the set. The plurality of user interface elements in the set would, however, display additional contextual content as the apparatus moved from the first operational mode to the second operational mode.

The apparatus may be configured such that the plurality of user interface elements in the set may not allow interaction with the associated respective applications in the first operational mode, but may allow interaction with the associated respective applications in the second operational mode. When the apparatus is operating in the first operational mode, any user interface element forming part of the set of the plurality of user interface elements may not allow a user to interact with it, for example, to access the application with which the user interface elements is associated. Interaction with that user interface element may be allowed when the apparatus is operating in the second operational mode.

The apparatus may be configured such that the plurality of user interface elements in the set may allow interaction with the associated respective applications in the first operational mode and in the second operational mode. For example, a user may be able to access some functionality of the application associated with a particular user interface element in the set of the plurality of user interface elements, whether the apparatus is operating in the first operational mode or in the second operational mode.

The apparatus may be configured such that interaction with the associated respective applications may allow access to functionality of the associated respective applications. Such functionality may comprise the application being opened on the apparatus, information about the application being displayed (such as time last used, details of any updates available for that application, or authorship details), or the ability to input content and receive content using that application. The application may have been opened on the apparatus or functionality of the application may be made available on the apparatus in a widget-type user interface element, for example.

The apparatus may be configured such that the set of the plurality of user interface elements may be hidden upon the provision of a particular user input. The set of the plurality of user interface elements may, in other example, be automatically hidden after a predetermined period of user inactivity with the apparatus.

The apparatus may be configured such that the hidden set of the plurality of user interface elements is revealed/displayed upon the provision of particular user input. The apparatus may be configured such that the plurality of user interface elements in the set are grouped together within a defined privacy area, and wherein the privacy area can be hidden and revealed upon the provision of respective particular user inputs. That is, the set of the plurality of user interface elements may be displayed in a portion of the display of the apparatus, and the portion of the display may be labelled a “privacy area”. The portion of the display (the privacy area) may be hidden from view and brought into view via a particular user input. Hidden may comprise the set being absent from view entirely, or may comprise a representative symbol or icon being displayed, the selection of which causes the set to be re-displayed. The particular user input used to hide and/or reveal the privacy area may be, for example, a slide, swipe or flick input gesture made from one edge of the display, a double tap or a multi-finger tap in any or in one or more particular regions of the display, or other suitable user input (gesture).

The apparatus may be configured such that after a predetermined period of inactivity of the apparatus operating in the second operational mode, the apparatus may move to operating in the first operational mode. Thus the user may be using the apparatus operating in the second operational mode, and then the user may put the apparatus to one side and stop interacting with it. Rather than the user having to consciously move the apparatus back into the first operating mode (by entering a password, selecting a “change mode” option or selecting a lock icon, for example), the apparatus may automatically revert to operating in the first operational mode after a predetermined period of time. This period of time may be set as a factory setting of the device or may be determined by the user. The period of time may, for example, be five minutes (or longer, or shorter).

The apparatus may be configured such that at least one of the plurality of user interface elements in the set in the second operational mode may be displayed as a widget. The apparatus may be configured such that at least one of the plurality of user interface elements in the set may be displayed as a widget in the second operational mode and as an application icon in the first operational mode. The apparatus may be configured such that at least one of the plurality of user interface elements in the set in the second operational mode may be displayed as an application icon.

A widget may be considered to be a type of user interface element which displays some variable content, which may be contextual content. For example, a football scores widget may update to display the latest score in an ongoing football match. A music player application widget may display details about the song currently playing, or the last song played. A widget may also comprise some basic-level interaction controls. For example in the case of the music player, the widget may comprise a volume control, play/pause buttons, and a skip track button.

A widget may display contextual content such as displaying the name of a contact having recently sent an e-mail in an e-mail application widget, or displaying thumbnail images of photographs/movies in a social networking application widget, which a social networking contact has uploaded, and which can be seen in full in the relevant associated application.

An application icon may be considered to display a symbolic representation of an associated application (as may a widget), but an application icon may not comprise basic-level interaction controls. An application icon may comprise an indicator, indicating, in the example of an alarm application icon, the number of times an alarm has sounded without the user interacting with the alarm application, for example to turn the alarm off.

The apparatus may be configured such that a particular user interface element outside the set of the plurality of user interface elements may be moved such that the particular user interface element forms part of the set of the plurality of user interface elements. That is, a user interface element may be outside the set of the plurality of user interface elements, such as an icon displayed on the general desktop or another part of a homescreen, for example. The user may decide that they want this icon to only show limited contextual content unless the apparatus is operating in the second operational mode, therefore the user may move this icon, for example by dragging it into a privacy area. The icon then forms part of the set of the plurality of user interface elements.

The apparatus may be configured such that a particular user interface element within the set of the plurality of user interface elements may be moved such that the particular user interface element is outside the set of the plurality of user interface elements. That is, a user interface element may be in the set of the plurality of user interface elements, such as a widget displayed in a privacy area. The user may decide that they do not wish this user interface element to be in the privacy area any longer, and therefore the user may move this widget, for example by dragging it out of the privacy area onto a general desktop, or another part of the homescreen, for example, of the apparatus. Thus the widget is then outside the set of the plurality of user interface elements.

The apparatus may be a portable electronic device, a laptop computer, a mobile phone, a Smartphone, a tablet computer, a personal digital assistant, a digital camera, a watch, a non-portable electronic device, a desktop computer, a monitor, a server, or a module/circuitry for one or more of the same.

In a further aspect there is provided a method, the method comprising providing for first and second operational modes for a set of a plurality of user interface elements, the plurality of user interface elements in the set being associated with respective applications, providing for displaying of the set of the plurality of user interface elements in the first operational mode such that limited contextual content is provided, the limited contextual content being associated with the respective applications and providing for displaying of the set of the plurality of user interface elements in the second operational mode such that additional contextual content is provided, the additional contextual content being associated with the respective applications.

In a further aspect there is provided a computer readable medium comprising computer program code stored thereon, the computer readable medium and computer program code being configured to, when run on at least one processor, perform at least the following: provide for first and second operational modes for a set of a plurality of user interface elements, the plurality of user interface elements in the set being associated with respective applications, wherein in the first operational mode, the set of the plurality of user interface elements is displayed such that limited contextual content is provided, the limited contextual content being associated with the respective applications and in the second operational mode, the set of the plurality of user interface elements is displayed such that additional contextual content is provided, the additional contextual content being associated with the respective applications.

In a further aspect there is provided an apparatus, the apparatus comprising means for providing for first and second operational modes for a set of a plurality of user interface elements, the plurality of user interface elements in the set being associated with respective applications, wherein in the first operational mode, the set of the plurality of user interface elements is displayed such that limited contextual content is provided, the limited contextual content being associated with the respective applications and in the second operational mode, the set of the plurality of user interface elements is displayed such that additional contextual content is provided, the additional contextual content being associated with the respective applications.

In a further aspect there is provided an operational mode provider, wherein the operational mode provider is configured to provide for first and second operational modes for a set of a plurality of user interface elements, the plurality of user interface elements in the set being associated with respective applications, wherein in the first operational mode, the set of the plurality of user interface elements is displayed such that limited contextual content is provided, the limited contextual content being associated with the respective applications and in the second operational mode, the set of the plurality of user interface elements is displayed such that additional contextual content is provided, the additional contextual content being associated with the respective applications.

The present disclosure includes one or more corresponding aspects, embodiments or features in isolation or in various combinations whether or not specifically stated (including claimed) in that combination or in isolation. Corresponding means or functional units for performing one or more of the discussed functions are also within the present disclosure.

Corresponding computer programs for implementing one or more of the methods disclosed are also within the present disclosure and encompassed by one or more of the described embodiments.

The above summary is intended to be merely exemplary and non-limiting.

### BRIEF DESCRIPTION OF THE FIGURES

A description is now given, by way of example only, with reference to the accompanying drawings, in which:

FIG. 1 illustrates an example apparatus according to the present disclosure;

FIG. 2 illustrates another example apparatus according to the present disclosure;

FIG. 3 illustrates another example apparatus according to the present disclosure;

FIGS. 4a-4c illustrate an example apparatus operating in the first and second operational modes, and shows the entry of a user identification/passcode to move between modes;

FIGS. 5a-5d illustrate an example apparatus hiding and displaying a secret area containing user interface elements;

FIGS. 6a-6d illustrate an example apparatus, and show how a user may initially set up a privacy area containing user interface elements;

FIG. 7 illustrates a flowchart according to a method of the present disclosure; and

FIG. 8 illustrates schematically a computer readable medium providing a program.

### DESCRIPTION OF EXAMPLE ASPECTS/EMBODIMENTS

Portable electronic devices, such as mobile telephones, tablet PCs, smartphones and personal media players may be configured to allow several applications to be run on the device. Often, such a device can display at least one home screen containing user interface elements. A user interface element may be an icon, for example. Each user interface element may be associated with an application, and upon a user selecting a particular user interface element, functionality of that application may be accessed, for example, the application may run on the device.

An icon may, for example, display the name of the associated application and/or a symbol indicating an associated application. For example, an icon for the social media microblogging site Twitter may contain the label “Twitter” alongside an icon of the Twitter stylised bird image. In some cases, an indicator may also be displayed on the icon. Such an indicator may show, for an icon associated with an e-mail application, the number of unread e-mail messages, or for a social media application, the number of unread messages/posts and/or updates available for a user to read.

Other user interface elements may display further content associated with the corresponding application. Such other user interface elements may include so-called “widgets”. Further content may include, in the example of a photo application, thumbnail images of the most recently taken photographs, or in the example of an SMS messaging application, the name of the sender and the initial portion of the most recently received SMS messages. This further content may be considered to be private/personal content, in that the user of the portable electronic device may not wish other people to see any details of his photographs, SMS messages, or other personal content. Such further content may also be considered to be contextual content, since it is content displayed in the context of the user's operation and use of the portable electronic device and any associated applications.

It may be possible to configure the portable electronic device to be password protected, so that the home screen and any displayed user interface elements are viewable and accessible only after the entry of a correct password. In this case, the whole user interface would be unavailable until the correct password is provided to the portable electronic device.

It may also be possible to configure the portable electronic device such that an individual application may be password protected. In this case, a user may set up, for example, his e-mail application to be password protected. It may be that an icon associated with the e-mall application is displayed on the home screen of the portable electronic device, but that the particular application is inaccessible until a password has been correctly entered for that particular application. A user may be able to set up multiple such passwords for respective multiple applications.

FIG. 1 shows an apparatus 100 comprising a processor 110, memory 120, input I and output O. In this embodiment only one processor and one memory are shown but it will be appreciated that other embodiments may utilise more than one processor and/or more than one memory (e.g. same or different processor/memory types). The apparatus 100 may be an application specific integrated circuit (ASIC) for a portable electronic device. The apparatus 100 may also be a module for a device, or may be the device itself, wherein the processor 110 is a general purpose CPU and the memory 120 is general purpose memory.

The input I allows for receipt of signalling to the apparatus 100 from further components. The output O allows for onward provision of signalling from the apparatus 100 to further components. In this embodiment the input I and output O are part of a connection bus that allows for connection of the apparatus 100 to further components. The processor 110 is a general purpose processor dedicated to executing/processing information received via the input I in accordance with instructions stored in the form of computer program code on the memory 120. The output signalling generated by such operations from the processor 110 is provided onwards to further components via the output O.

The memory 120 (not necessarily a single memory unit) is a computer readable medium (such as solid state memory, a hard drive, ROM, RAM, Flash or other memory) that stores computer program code. This computer program code stores instructions that are executable by the processor 110, when the program code is run on the processor 110. The internal connections between the memory 120 and the processor 110 can be understood to provide active coupling between the processor 110 and the memory 120 to allow the processor 110 to access the computer program code stored on the memory 120.

In this embodiment the input I, output O, processor 110 and memory 120 are electrically connected internally to allow for communication between the respective components I, 0, 110, 120, which in this example are located proximate to one another as an ASIC. In this way the components I, 0, 110, 120 may be integrated in a single chip/circuit for installation in an electronic device. In other embodiments one or more or all of the components may be located separately (for example, throughout a portable electronic device such as devices 200, 300, or through a “cloud”, and/or may provide/support other functionality.

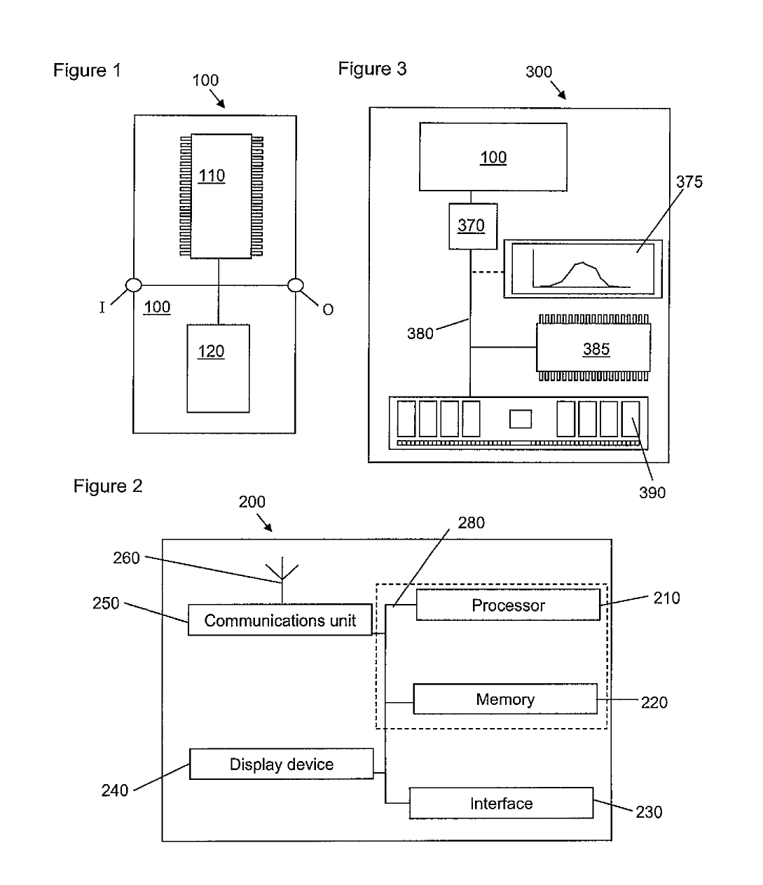

One or more examples of the apparatus 100 can be used as a component for another apparatus as in FIG. 2, which shows a variation of apparatus 100 incorporating the functionality of apparatus 100 over separate components. In other examples the device 200 may comprise apparatus 100 as a module (shown by the optional dashed line box) for a mobile phone or PDA or audio/video player or the like. Such a module, apparatus or device may just comprise a suitably configured memory and processor.

The example apparatus/device 200 comprises a display 240 such as, a Liquid. Crystal Display (LCD), e-Ink, or touch-screen user interface. The device 200 is configured such that it may receive, include, and/or otherwise access data. For example, device 200 comprises a communications unit 250 (such as a receiver, transmitter, and/or transceiver), in communication with an antenna 260 for connection to a wireless network and/or a port (not shown). Device 200 comprises a memory 220 for storing data, which may be received via antenna 260 or user interface 230. The processor 210 may receive data from the user interface 230, from the memory 220, or from the communication unit 250. Data may be output to a user of device 200 via the display device 240, and/or any other output devices provided with apparatus. The processor 210 may also store the data for later user in the memory 220. The device contains components connected via communications bus 280.

The communications unit 250 can be, for example, a receiver, transmitter, and/or transceiver, that is in communication with an antenna 260 for connecting to a wireless network and/or a port (not shown) for accepting a physical connection to a network, such that data may be received via one or more types of network. The communications (or data) bus 280 may provide active coupling between the processor 210 and the memory (or storage medium) 220 to allow the processor 210 to access the computer program code stored on the memory 220.

The memory 220 comprises computer program code in the same way as the memory 120 of apparatus 100, but may also comprise other data. The processor 210 may receive data from the user interface 230, from the memory 220, or from the communication unit 250. Regardless of the origin of the data, these data may be outputted to a user of device 200 via the display device 240, and/or any other output devices provided with apparatus. The processor 210 may also store the data for later user in the memory 220.

Device/apparatus 300 may be an electronic device (including a tablet personal computer), a portable electronic device, a portable telecommunications device, or a module for such a device. The apparatus 100 of FIG. 1 can be provided as a module for device 300, or even as a processor/memory for the device 300 or a processor/memory for a module for such a device 300. The device 300 comprises a processor 385 and a storage medium 390, which are electrically connected by a data bus 380. This data bus 380 can provide an active coupling between the processor 385 and the storage medium 390 to allow the processor 380 to access the computer program code.

The apparatus 100 in FIG. 3 is electrically connected to an input/output interface 370 that receives the output from the apparatus 100 and transmits this to the device 300 via data bus 380. Interface 370 can be connected via the data bus 380 to a display 375 (touch-sensitive or otherwise) that provides information from the apparatus 100 to a user. Display 375 can be part of the device 300 or can be separate. The device 300 also comprises a processor 385 that is configured for general control of the apparatus 100 as well as the device 300 by providing signalling to, and receiving signalling from, other device components to manage their operation.

The storage medium 390 is configured to store computer code configured to perform, control or enable the operation of the apparatus 100. The storage medium 390 may be configured to store settings for the other device components. The processor 385 may access the storage medium 390 to retrieve the component settings in order to manage the operation of the other device components. The storage medium 390 may be a temporary storage medium such as a volatile random access memory. The storage medium 390 may also be a permanent storage medium such as a hard disk drive, a flash memory, or a non-volatile random access memory. The storage medium 390 could be composed of different combinations of the same or different memory types.

A portable electronic device may display user interface elements which provide some level of personal content, such as widgets. It may be useful for a user to be able to configure the device to display such user interface elements as icons or as other user interface elements which do not provide any level of personal content, or provide only limited personal content. For example, providing only a numeral indicator for, for example, the number of unread received messages may be considered as providing limited contextual content. It may be advantageous for a user to be able to enter a passcode or other identification, and thus cause the user interface element to change from being displayed in the “limited” form, that is, without or with very limited personal content displayed, to being displayed in such a way that some personal content is displayed in the user interface element.

It may also be useful for a user to be able to enter a single passcode (or similar) to change the display of a group of two or more user interface elements on the home screen of his or her portable electronic device, from being displayed with very limited or no personal content, to being displayed with some level of personal content. This may be desirable if a user does not want other people to be able to look at the home screen of his or her portable electronic device and see displayed personal content, shown In some user interface elements. It may be advantageous also for a user to be able to enter a single passcode and move from a mode where a group of applications are inaccessible to a mode where the group of applications are accessible. It may be useful for the user not to have to individually password-protect each individual application in a group of applications.

It may also be useful for a user to be able to readily show and hide the region or area of the home screen of his or her portable electronic device containing user interface elements which may display personal/contextual content. This may be the case if a user does not want other people to know that the portable electronic device is configured such that certain user interface elements can be controlled to show or hide associated personal content.

It may also be desirable for a user to be able to readily hide and display certain user interface elements in a region of the home screen, regardless of if the user interface element displays any personal/contextual content. For example, a user may have an application available on their portable electronic device which is related to a private matter and which they may not wish others to see on their homescreen, even if the associated user interface element does not show any personal/contextual content. Such an application may be, for example, a weight loss application, a pregnancy planning application, or a job searching application.

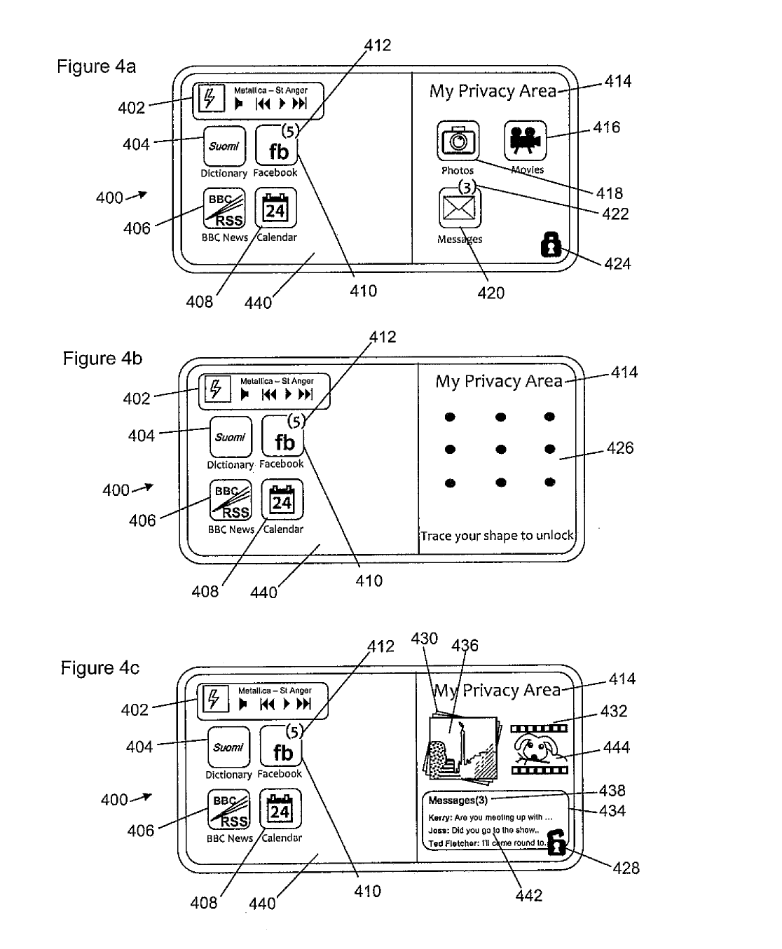

FIGS. 4a-4c illustrate an example embodiment of the apparatus which is a portable electronic device 400, such as a smartphone, tablet computer or PDA, in use. The device 400 in this example is displaying a home screen of the apparatus including a privacy area 414 and a general non-privacy area 440. In this example, the privacy area and general non-privacy area are demarked/visually separated by a vertical line. In other examples, demarcation may not be provided. In certain cases, the user interface elements may not appear any differently in the first or second operational modes in that they are not otherwise distinguished to be different on the display.

In FIGS. 4a-4c, the general non-privacy area 440 in this example is displaying a widget-type user interface element 402 corresponding to a music player application. Also displayed in the general non-privacy area 440 are four icon-type user interface elements 404, 406, 408, 410. Icon 404 is associated with a Finnish dictionary application, icon 406 is associated with an RSS news feed application, icon 408 is associated with a calendar application, and icon 410 is associated with a social media application. Icon 410 is also displaying limited contextual content in the form of an indicator 412 of the number of unread posts in the social media application.

In FIG. 4a the apparatus/device is providing a first operational mode for the set of the plurality of user interface elements 416, 418, 420. The plurality of user interface elements 416, 418, 420 in the set are associated with respective applications. For example, user interface element 416 is associated with a movie making/playing application, user interface element 418 is associated with a photo application, and user interface element 420 is associated with a messaging application.

The privacy area 414 in FIG. 4a in this example is displaying the set of three user interface elements 416, 418, 420. The user interface elements are currently being displayed as icons because the apparatus/device is operating in the first operational mode. The privacy area 414 may be thought of as “locked”, as indicated by the padlock symbol 424. In this example, “locked” means that the set of the plurality of user interface elements 416, 418, 420 in the first operational mode is displayed. The limited contextual content in this case comprises the indicator 422 of user interface element 420. This indicator 422 is associated with the respective application of the messaging application, in that it is an indicator 422 indicating the number of unread messages which may be read and interacted with via the messaging application associated with the user interface element 420. The set of the plurality of user interface elements 416, 418, 420 is provided in this example in a discrete defined area of the display of the apparatus, labelled in this example as “My Privacy Area” 414.

In this example, the set of the plurality of user interface elements in the first operational mode 416, 418, 420 represent a sub-set of the plurality of user interface elements 402, 404, 406, 408, 410, 416, 418, 420 available to a user (e.g. on the home screen) of the electronic device 400. Similarly the set of the plurality of user interface elements in the second operational mode 430, 432, 434 also represent a sub-set of the plurality of user interface elements 402, 404, 406, 408, 410, 430, 432, 434 available to a user (e.g. on the home screen) of the electronic device 400.

In this example, the user interface elements in the privacy area 414 have been located in that area because the user has decided that only she should be able to see any contextual or personal content associated with these applications. The user interface elements 416, 418, 420 in FIG. 4a display limited contextual content as icons while the privacy area 414 is locked, that is, while operating in the first operational mode. Upon unlocking the privacy area 414 as shown in FIG. 4c, thus accessing the second operational mode, these user interface elements will be displayed with additional contextual content. In FIG. 4c these user interface elements are displayed as widgets 430, 432, 434.

In FIG. 4b, the user wishes to move from the first operational mode as shown in FIG. 4a to the second operational mode shown in FIG. 4c. To display the screen as shown in FIG. 4b, the user has provided an indication that she wishes to enter a password to move to the second operational mode. This indication may be, for example, the user touching the padlock symbol 424 in the privacy area 414 in the first operational mode or may comprise a different user input or gesture.

The user is required in this example, as shown in FIG. 4b, to trace a particular shape in order to move from the first to the second operational mode. Therefore the apparatus is configured to move between the first and second operational modes by the provision of a single user identification for the set of the plurality of user interface elements. The single user identification, in this example, is in the form of a particular shape which needs to be traced on the screen in area 426. This single user identification allows for the set of the plurality of user interface elements 416, 418, 420 in the first operational mode to move to being the set of the plurality of user interface elements 430, 432, 434 in the second operational mode.

The user may have previously set up the apparatus to define a particular shape as the identification shape for moving between the first and second operational modes. In other examples, the user may be required to enter an alphanumeric passcode, personal identification number (PIN), perform a particular user gesture, or scan their fingerprint (if the apparatus has fingerprint scanning capabilities) in order to move between the first and second operational modes. The apparatus may comprise a camera and facial recognition software or iris recognition software as known in the art which may be used for user identification.

The user may move between the first and second operational modes by providing a single user identification (in this case, a preset particular shape), for the set of the plurality of user interface elements 416, 418, 420. That is to say, the correct entry of a single user identification moves the device from operating in the first to the second operational mode, and correspondingly all the user interface elements in the set are shown in the second operational mode with associated additional contextual content. Separate user identifications are not required for each application having an associated user interface element in the privacy area. Similarly, not all user Interface elements are configured to be locked/protected by the user identification. User interface elements 402, 404, 406, 408, 410 in the general non-privacy area 440 appear in the same way and provide the same level of contextual content in both the first and second operating modes of the apparatus.

As discussed, in some examples the apparatus may be configured to move between the first and second operational modes by the provision of single user identification for the set of the plurality of user Interface elements, thereby showing additional contextual content for the plurality of user interface elements in the set. Additionally, the apparatus may also be configured so that one or more of the plurality of user interface elements in the set requires individually an additional password to be entered for access to the functionality of the application associated with that particular user interface element. That is, upon entering the second operational mode, a user interface element may provide additional contextual content on the home screen, but an additional password may still be required to, for example, open and run the application linked to the user interface element.

For example, a user may have widgets located in the privacy area of their apparatus/device. The apparatus may move from the first operational mode to the second operational mode by the provision of a single user Identification, thereby displaying additional contextual content for the plurality of user interface elements (widgets) in the set. If one of the user interface elements in the set was associated with the user's e-mail accounts, for example, then the user may wish that in addition to being able to show and hide contextual content in the widget for this e-mailing application, that the application should also individually be password protected so that, for example, if the user's device was lost or stolen, an unauthorised person would not be able to so readily gain access to that application and the personal content therein. Other exemplary applications which a user may wish to additionally password protect may include financial and banking applications, links to online shopping sites where the user's financial details may be saved, private photograph galleries, and social media applications.

It may be that the provision of a passcode is required to move from the first to the second operational mode, and that, after a predetermined period of inactivity of the apparatus operating in the second operational mode, the apparatus can move to operating in the first operational mode. In other examples it may be that the apparatus can be moved from operating in the second to the first operational mode by the user simply touching the unlocked padlock icon 428, or similar, displayed in the second operational mode. In other examples, the user may be able to perform a user input or gesture to move to the first operational mode from the second operational mode.

In the second operational mode shown in FIG. 4c, the set of the plurality of user interface elements 430, 432, 434 is displayed such that additional contextual content 436, 442, 444 is provided. The additional contextual content 436 is a thumbnail of the last photograph taken associated with the respective application of the photo application, the additional contextual content 442 is a summary of the last received messages including the names of the senders and the initial portion of each displayed last received message, and the additional contextual content 444 is a still from the latest movie recorded by the user using the apparatus. The indicator 438 in FIG. 4c corresponds to the limited contextual content 422 provided in the first operational mode in FIG. 4a. The size of the privacy area may not only be restricted to the area shown in the example of FIG. 4c. For example, a privacy area may have scroll bar/scrolling functionality so that the user can move around the privacy area and access more user interface elements in the privacy area than can be displayed on the display at any one time.

The additional contextual content 438, 442, 444 provided in the second operational mode is additional with respect to the limited contextual content 422 provided in the first operational mode. The unread message indicator 422 shown in the first operational mode in FIG. 4a is also shown as an unread message indicator 438 in the second operational mode in addition to the details of the most recently received messages 442 shown in the widget 434 in FIG. 4c.

From FIG. 4c, it can be seen that at least one (in this example, three) of the plurality of user interface elements in the set is displayed as a widget in the second operational mode; user interface elements 430, 432, 434 are displayed as widgets. These user interface elements 430, 432, 434 are displayed as application icons 416, 418, 420 in the first operational mode as shown in FIG. 4a. In other examples, at least one of the plurality of user interface elements in the set in the second operational mode may be displayed as an application icon in the same way as in the first operational mode. That is, it is not forbidden to locate a user interface element in the privacy area which appears in the same way in the first and second operational modes.

In this example, the user is unable to interact with the user interface elements in the privacy area 414 while the apparatus/device is operating in the first operational mode, but is able to interact with the user Interface elements in the privacy area 414 in the second operational mode. That is to say, the plurality of user Interface elements in the set 416, 418, 420 do not allow Interaction with the associated respective applications in the first operational mode shown in FIG. 4a, but the plurality of user interface elements in the set 430, 432, 434 allow interaction with the associated respective applications in the second operational mode.

The user is able to interact with the user interface elements 430, 432, 434 in the second operational mode, for example, by touching one of the user interface elements to select it. Thus the user is able to actuate the respective application associated with that user interface element and access functionality of that application. In the second operational mode, for example, the user may be able to select the messaging widget 434 to open the messaging application and read any messages in full, as well as compose a new message, file messages, delete messages, and access other functionality.

In other examples the plurality of user interface elements in the set may allow interaction with the associated respective applications in both the first operational mode and the second operational mode. In these examples, it may be beneficial to the user that privacy area 414 may be hidden from view, perhaps by being “minimised” to appear as a symbol or icon, or hidden from view entirely with no associated symbol or other indication being displayed. The user may be able to enter a particular user input, for example, a double tap in a particular location of a home screen, or a slide up from the bottom of the display, in order to display the hidden set of the plurality of user interface elements located in the privacy area 414.

As mentioned previously, the user interface elements which provide additional contextual content in the second operational mode may not be otherwise distinguished/demarked from the user interface elements outside the set which provide the same level of contextual content in both the first and second operational modes. Thus, one cannot readily distinguish that some user interface elements may appear differently in the two operational modes.

It can be seen from FIGS. 4a and 4c that the user interface elements 402, 404, 406, 408, 410 outside the sub-set of the plurality of user interface elements provide the same level of contextual content in the first operational mode as in the second operational mode. The contextual content provided in both the first and second operational modes can be seen to be the album cover art, artist name and song name of the last played track in the music playing application associated with the music player widget 402, and the five unread social media updates indicated 412 on the social media application icon 410.

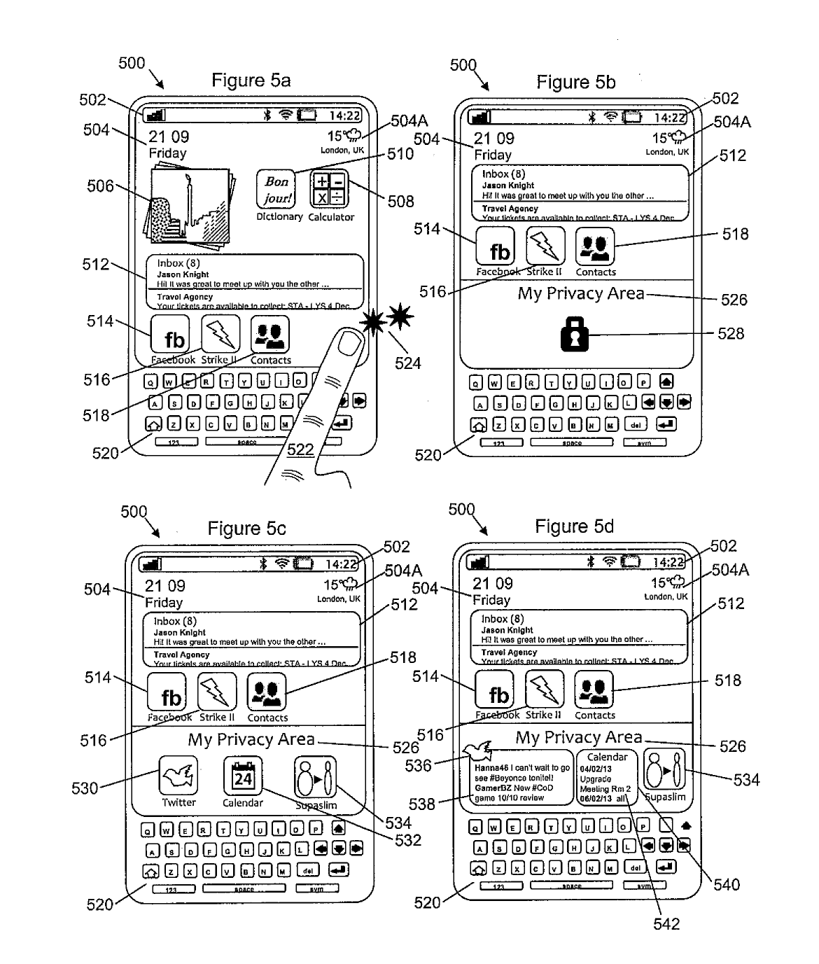

FIGS. 5a-5d illustrate an example embodiment of the apparatus which is a portable electronic device 500, such as a smartphone, tablet computer or FDA, in use. The device 500 in this example has a physical keyboard 520. The user wishes to display the hidden privacy area.

In FIGS. 5a-5d, the apparatus/device is displaying some content regarding operation of the device 502 such as the signal strength, Bluetooth® connectivity, network connectivity, battery power remaining, and the current time. Other content is displayed including the current day and date 504 and the current location and weather conditions 504A.

The home screen is also displaying a photo application user interface element (widget) 506 showing a thumbnail image of a photograph taken, a user interface element (widget) 512 for an e-mail application, and five user interface elements (icons) for a calculator application 508, a French dictionary application 510, a social media application 514, a game application 516 and a contacts list application 518.

In FIG. 5a, the privacy area, containing the set of the plurality of user interface elements, is hidden from view. The user wishes to display/reveal the privacy area and so performs/provides a particular user input in order to display the privacy area. In this example the particular user input is a double tap of the user's finger on a region of the display not corresponding to the location of a user interface element. This is only one exemplary particular user input, and many other may be envisaged and are included within the scope of this disclosure. Other particular user inputs include, for example, a slide/swipe/flick motion from the top, bottom or a side of the display towards the centre of the display, a two-finger tap/slide in a particular region of the display, a voice-recognised spoken command, pressing a particular combination of keys on the physical keyboard 520, or a static or moving hover gesture over a particular location of the display (if configured for proximity-sensitivity). In the case where a hidden privacy area is indicated to a user of the device by a displayed symbol or icon, interacting with that icon, for example by clicking or touching it, may cause the hidden privacy area to be displayed.

FIG. 5b shows the apparatus/device 500 operating in the first operational mode with the privacy area 516 displayed. In this example, no details of any user interface elements located in the privacy area 526 are provided, and instead a padlock icon 528 is shown to indicate that the device is operating in the first operational mode and thus only limited (in this case, no) contextual content is provided. The user may unlock this privacy area 526 by, for example, providing user identification as discussed above in relation of FIGS. 4a-4c.

FIG. 5c shows the apparatus/device 500 operating in the first operational mode with the privacy area 516 displayed. In this example, limited contextual content is provided for the user interface elements 530, 532, 534 displayed in the privacy area 526. In this example, no contextual content is provided by these user Interface elements. In other examples, limited contextual content such as an unread message indicator may be displayed. The user may provide a user identification to move from the first operational mode to the second operational mode and thereby access additional contextual content associated with the user interface elements 530, 532, 534 in the privacy area 526.

FIG. 5d shows the apparatus/device 500 operating in the second operational mode with the privacy area 526 displayed. In this example, additional contextual content 538, 542 is provided with the user interface elements 536, 540 located in the privacy area 526 (additional in comparison to the limited contextual content provided in the first operational modes shown in FIGS. 5b and 5c). In this example the additional contextual content provided with user interface element 536 comprises details of the latest microblog posts 538 from the user's Twitter feed, and the additional contextual content provided with user interface element 540 are details of the upcoming calendar entries 542 for the user. The user also wants the user interface element 534 to be kept in the privacy area. The user interface element 534 relates to a weight loss application. Even though the same (that is, no) contextual content is displayed associated with this user interface element 534 whether the privacy area is locked or unlocked, that is, whether the apparatus is in the first or second operational mode, the user does not want other people to know that they are interested in watching their weight, so they have moved this user interface element 534 into the privacy area.

It may be that the user can control the display or concealment of the privacy area in the second mode. For example, the user may be operating the portable electronic device in the second operational mode as shown in FIG. 5d, thereby accessing additional contextual content (which may include the display of private information). If another person approaches the user, the user may wish to quickly hide any displayed personal content in a discreet manner. Thus the user may be able to, for example, provide a slide user input to drag the privacy area down to the bottom of the display to give a displayed homescreen as shown in FIG. 5a and conceal the privacy area. The user may be able to provide another user input, for example, a slide up from the bottom of the display, to automatically re-display the privacy area as shown in FIG. 5d. This re-displaying may, in some examples, only be permitted within a specified time window beginning at the point when the privacy area was concealed (for example, up to two minutes after concealment). Of course, the re-display may first again require user authentication (e.g. by entering a password) as previously discussed.

In other examples, it may be possible to show and hide the privacy area while an application is running (e.g. in a ‘privacy area’ bar running across the bottom of the display with the display also showing the running application). Therefore it may not necessarily be the home screen which is displayed as in FIG. 5a, but a screen corresponding to the running application. It may also be possible, while an application is running and being displayed on the apparatus/device, to interact with user interface elements in the privacy area. It may also be possible, while an application is running and being displayed on the apparatus/device, to interact with the privacy area itself, to move from the first to the second operational modes and view additional contextual content associated with the user Interface elements located in the privacy area.

Thus for example, a user may be running an application such as a word processing application, and be able to check their social media updates in a social media widget located in the privacy area and displayed when the apparatus is operating in the second operational mode without having to leave the running application. If operating in the first operational mode, the corresponding user interface element may be, for example, an icon displaying limited contextual content. The user would be able to readily show and hide such a privacy area while the word processing application Is running.

An apparatus may be configured to provide more than one privacy area. A user may wish to use multiple privacy areas, for example one privacy area may be used for messaging applications such as social media, e-mail, and SMS messaging applications, another privacy area may be used for image, photographic and video applications, and another privacy area may be used for financial and budgeting applications. It may be imagined that one privacy area may be displayed at the bottom portion of a display, and another may be displayed at the top of the display. The separate privacy areas may be displayed simultaneously in some examples, or only one privacy area at a time may be displayed in other examples. It may be that different user inputs may be used to hide/display the respective different privacy areas. One user identification/passcode/authentication may be used to move the apparatus from the first operational mode to the second operational mode and thereby display contextual content related to user interface elements located in all the privacy areas.

In general, a user of an apparatus as described herein may wish to utilise the privacy area and first and second operational modes to allow any user interface elements associated with personal information to be located in the privacy area (or at least to be considered private), with any user interface elements associated with utility tools to be located in the general non-private area. For example, a user may locate user interface elements relating to utility tools such as weather applications, calculator applications, time and date applications or reference applications such as a dictionary or currency converter in the general area. The user may then wish that any user interface elements associated with personal data applications, such as e-mail or messaging applications, photograph, image or gallery applications, social media applications, financial applications, or other applications concerning a sensitive subject (for example, a pregnancy planning application or a link to a job seeking website in an internet browsing application), to be located in the privacy area.

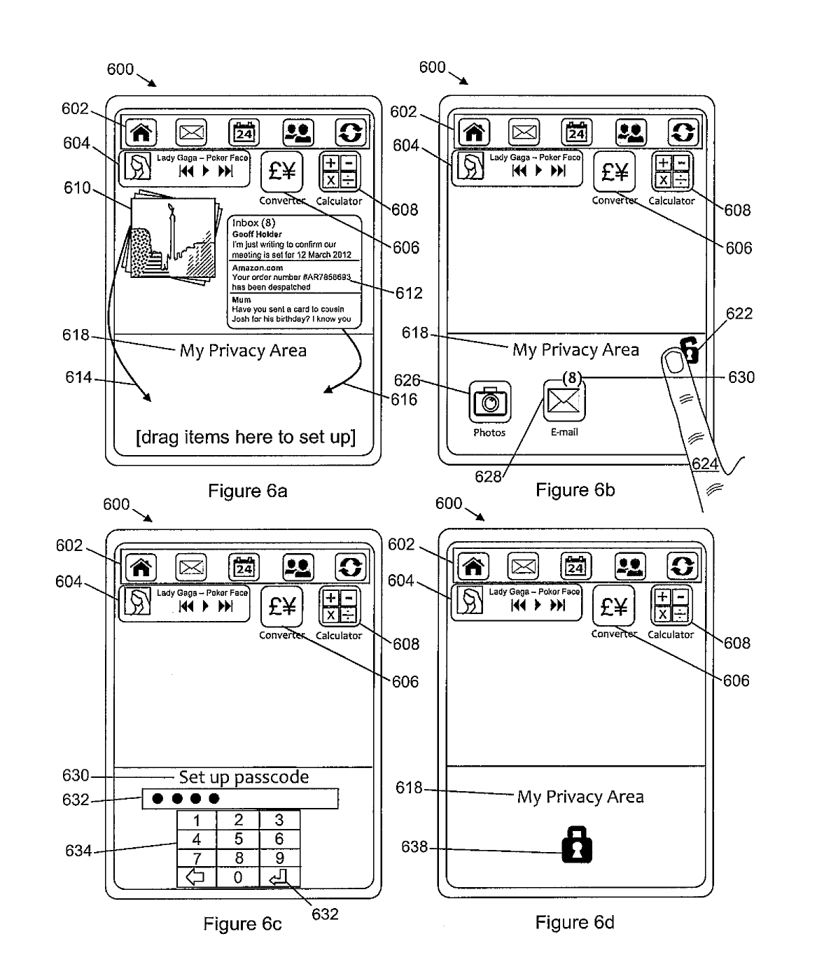

FIGS. 6a-6d illustrate an example embodiment of the apparatus which is a portable electronic device 600, such as a smartphone, tablet computer or PDA, in use. The device 600 in this example has a touch-sensitive screen, and the first and second operational modes are being set up for the first time by a user wishing to password protect access to the privacy area 618 of their apparatus/device.

FIG. 6a shows a device 600 which allows some general functionality illustrated by the icons 602. For example, a user may return to the home menu, access an e-mail/messaging application, access a calendar application, access a contacts list or refresh the device. The general non-private area in FIG. 6a shows a music player widget user interface element 604 allowing a user to operate some elements of an associated music player application (the user may play, or skip forward or back through the tracks). Two icon user interface elements 606, 608 allow a user to access a currency converter application and a calculator application. Widget user interface element 610 provides access to a photo gallery application and widget user interface element 612 provides a summary of recently received e-mails for an e-mailing application.

The user has decided to set up their privacy area for the first time, as they do not want other people to see details of their gallery photographs 610 nor to see details of their received e-mails 612 displayed on the home screen of their device 600.

In FIG. 6a the user drags 614, 616 the two widgets 610, 612 which they wish to locate in the privacy area into the privacy area region of the display 618. The user may change their mind and move one or more of the user interface elements back onto the home screen after moving it initially into the privacy area, and the user may be able to move additional user interface elements into the privacy area after Initially moving user interface elements 610, 612, if they wish to. FIG. 6b shows that the contextual content provided by the user interface elements 626, 628 is limited in comparison to the additional contextual content provided by the widgets 610, 612 when in the general non-privacy area in FIG. 6a. It may be in this example that upon determining that a user is locating user interface elements in a privacy area for the first time (that is, setting up the privacy area for use), the apparatus automatically moves to operating in the first operating mode. The apparatus may determine this by detecting that a user interface element has been moved from outside to within a privacy area for the first time. Additional contextual content associated with a user interface element is no longer displayed immediately upon the user interface element being moved to the privacy area. In FIG. 6b, the user has chosen which user interface elements they wish to be located in the privacy area for the moment, and wishes to set up the user identification for subsequent access to the set of the plurality of user interface elements 626, 628 in the privacy area. The user 624 in this example touches a “lock” symbol 622 in the privacy area in order to set up the user identification settings for the privacy area.

In other embodiments, the movement of user interface elements between respective marked areas may not be required to ensure that a particular user interface element will appear with a different level of contextual content in the first and second operational modes. For example, “right-clicking” in an application may cause a menu to appear, from which the user can choose to show the user interface element associated with that running application with a different level of contextual content in the first operational mode to the second operational modes. As another example, applications could be provided in a list, and particular applications could be selected from the list to be displayed with a different level of contextual content in the first and second operational modes.

FIG. 6c shows that the apparatus 600 is requesting the user to set up a passcode for subsequent entry into the privacy area; that is, the code which will move the apparatus from operating in the first operational mode to the second operational mode. In FIG. 6c the user is requested to enter a PIN passcode but in other examples the user may be requested to enter an alphanumeric pass code using a virtual (or physical) keyboard; enter a shape by tracing it on a touch-sensitive screen of the apparatus, make a particular user gesture to be associated with moving from the first to the second operational mode, provide a fingerprint to a fingerprint scanner, or configure face/iris recognition software available to the apparatus to allow moving between the first and second operative modes. There are many other ways by which a user identification or authentication may be made to an apparatus known in the art, which are included in the scope of this disclosure.

FIG. 6d shows that the apparatus/device is operating in the first operational mode and is not displaying any indication of the user interface elements located in the privacy area. The user may move into the second operational mode by, for example, tapping the padlock icon 638 and entering the passcode which they set up in the step shown in FIG. 6c. In other examples, the displayed privacy area 618 may show limited contextual content after the passcode access has been set up, as shown in FIG. 6b.

It will be appreciated that the assignment of user interface elements to the set of the plurality of user interface elements, that is, the movement, of user interface elements into the privacy area, or out of the privacy area (into, for example, a general desktop area), can be performed by a user at any time, at least in certain embodiments. The user may be required to perform suitable inputs to allow the movement of user Interface elements to and from the privacy area. The user may not only have the opportunity to configure which user interface elements form part of the set of the plurality of user interface elements upon the initial set-up of the privacy area. The user may change which user interface elements form part of the set of the plurality of user interface elements, and which user interface elements are outside the set of the plurality of user interface elements whenever they wish to, on the proviso that the user is able to supply to the apparatus with any appropriate passcode(s) required to allow moving user interface elements into and out of the set of the plurality of user interface elements.

Thus the apparatus may be configured such that a particular user interface element outside the set of the plurality of user interface elements may be moved such that the particular user interface element forms part of the set of the plurality of user interface elements. The user, having perhaps already configured a privacy area, may decide to move another user interface element from outside the set of the plurality of user interface elements (for example, from a general desktop) into the privacy area. They may do this, for example, by dragging the particular user interface element into the privacy area from the general desktop. It may be that the apparatus must be operating in the second operational mode to allow a particular user interface element to be dragged into the privacy area. In other examples, a particular user interface element may be dragged into the privacy area whether the apparatus is operating in the first or the second operational mode.

Conversely, the apparatus may be configured such that a particular user interface element within the set of the plurality of user interface elements may be moved such that the particular user interface element is outside the set of the plurality of user interface elements. For example, the user may have located a particular user interface element in the privacy area, and at a later time, the user may no longer wish that particular user interface element to be in the privacy area. They may then, for example, move that particular user interface element out from the privacy area onto, for example, a desktop, thereby moving the particular user interface element from the set of the plurality of user interface elements to be outside that set. The user may, for example, decide that they no longer want a particular user interface element to be private, or they may wish to make room in the privacy area for another user interface element to be moved into the privacy area. It may be in some examples that the user is only able to move user interface elements out from the privacy area (that is, move user interface elements out from the set of the plurality of user interface elements) when the apparatus is operating in the second operational mode.

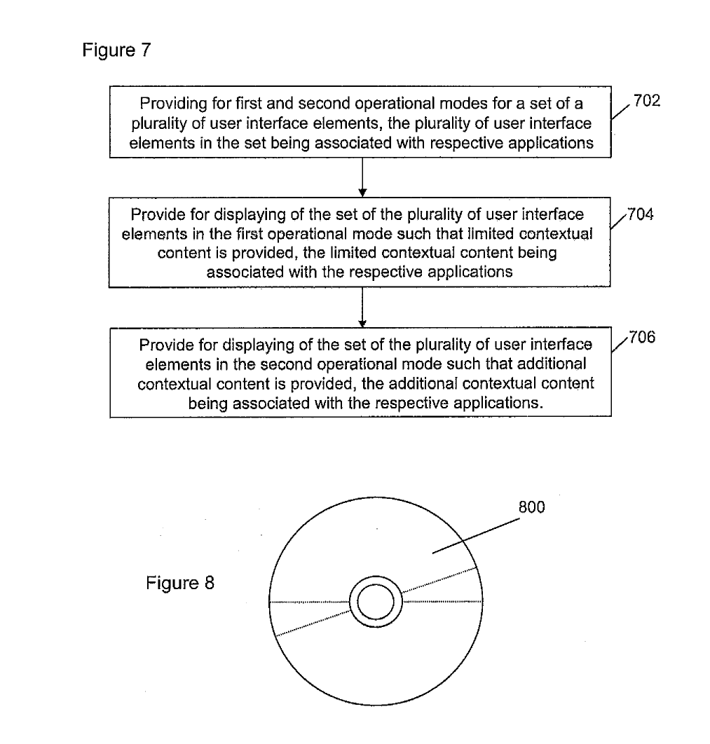

FIG. 7 shows a flow diagram illustrating the steps of providing for first and second operational modes for a set of a plurality of user interface elements, the plurality of user interface elements in the set being associated with respective applications 702, providing for displaying of the set of the plurality of user interface elements in the first operational mode such that limited contextual content is provided, the limited contextual content being associated with the respective applications 704 and providing for displaying of the set of the plurality of user interface elements in the second operational mode such that additional contextual content is provided, the additional contextual content being associated with the respective applications 706, and is self-explanatory.

FIG. 8 illustrates schematically a computer/processor readable medium 800 providing a program according to an embodiment. In this example, the computer/processor readable medium is a disc such as a digital versatile disc (DVD) or a compact disc (CD). In other embodiments, the computer readable medium may be any medium that has been programmed in such a way as to carry out an Inventive function. The computer program code may be distributed between the multiple memories of the same type, or multiple memories of a different type, such as ROM, RAM, flash, hard disk, solid state, etc.

The apparatus may comprise an operational mode provider. The operational mode provider may comprise hardware and/or software and be configured to provide first and second operational modes of an apparatus as described herein.

User inputs (for example, those made to display a hidden privacy area) may be inputs or gestures which comprise one or more of a tap, a swipe, a slide, a press, a hold, a rotate gesture, a static hover gesture proximal to the user interface of the device, a moving hover gesture proximal to the device, bending at least part of the device, squeezing at least part of the device, a multi-finger gesture, tilting the device, or flipping the device.

The examples described herein have been illustrated using a portable electronic device, such as a mobile phone, a Smartphone, a tablet computer, and a personal digital assistant. It will be appreciated that the disclosure also applies to the apparatus being a laptop computer, a digital camera, a watch, or a non-portable electronic device, such as a desktop computer, a monitor, a server, or a module/circuitry for one or more of the same.

Any mentioned apparatus/device and/or other features of particular mentioned apparatus/device may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

Any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
provide for first and second operational modes for a set of a plurality of user interface elements, the plurality of user interface elements in the set being associated with respective applications, wherein
in the first operational mode, the set of the plurality of user interface elements is displayed such that limited contextual content is provided, the limited contextual content being associated with the respective applications and
in the second operational mode, the set of the plurality of user interface elements is displayed such that additional contextual content is provided, the additional contextual content being associated with the respective applications.

2. The apparatus of claim 1, wherein the apparatus is configured such that the plurality of user interface elements in the set are associated with the actuation of respective applications.

3. The apparatus of claim 1, wherein the apparatus is configured to move between the first and second operational modes by the provision of a single user identification for the set of the plurality of user interface elements.

4. The apparatus of claim 1, wherein the apparatus is configured such that the set of the plurality of user interface elements is provided on a discrete defined area of a display of the apparatus.

5. The apparatus of claim 1, wherein the apparatus is configured such that the set of the plurality of user interface elements represent a sub-set of the plurality of user interface elements available to a user on a particular home screen of the apparatus.

6. The apparatus of claim 5, wherein the apparatus is configured such that the user interface elements outside the sub-set of the plurality of user interface elements provide the same level of contextual content in the first operational mode as In the second operational mode.

7. The apparatus of claim 1, wherein the apparatus is configured such that the set of the plurality of user interface elements, and other user interface elements outside that set, are displayed with no demarcation which would otherwise indicate which user interface elements form part of the set of the plurality of user interface elements and which user interface elements do not form part of that set.

8. The apparatus of claim 1, wherein the apparatus is configured such that the plurality of user interface elements in the set do not allow interaction with the associated respective applications in the first operational mode, but allow interaction with the associated respective applications in the second operational mode.

9. The apparatus of claim 1, wherein the apparatus is configured such that the plurality of user interface elements in the set allow interaction with the associated respective applications in the first operational mode and in the second operational mode.

10. The apparatus of claim 8, wherein the apparatus is configured such that interaction with the associated respective applications allows access to functionality of the associated respective applications.

11. The apparatus of claim 3, wherein the apparatus is configured such that the single user identification comprises one or more of a passcode, a PIN number, a shape traced on the apparatus, a fingerprint, a facial image, an iris image and a particular user gesture.

12. The apparatus of claim 1, wherein the apparatus is configured such that the set of the plurality of user interface elements is hidden upon the provision of a particular user input.

13. The apparatus of claim 12, wherein the apparatus is configured such that the hidden set of the plurality of user interface elements is revealed upon the provision of a particular user input.

14. The apparatus of claim 1, wherein the apparatus is configured such that the plurality of user interface elements in the set are grouped together within a defined privacy area, and wherein the privacy area can be hidden and revealed upon the provision of respective particular user inputs.

15. The apparatus of claim 1, wherein, the apparatus is configured such that after a predetermined period of inactivity of the apparatus operating in the second operational mode, the apparatus moves to operating in the first operational mode.

16. The apparatus of claim 1, wherein the apparatus is configured such that at least one of the plurality of user interface elements in the set in the second operational mode is displayed as a widget.

17. The apparatus of claim 1, wherein the apparatus is configured such that at least one of the plurality of user interface elements in the set is displayed as a widget in the second operational mode and as an application icon in the first operational mode.

18. (canceled)

19. The apparatus of claim 1, wherein contextual content comprises one or more of e-mail content, photographic content, image content, message content, notifications, social media content, RSS feed content, contact details, audio content, and a notification indicator.

20. (canceled)

21. (canceled)

22. (canceled)

23. A method, the method comprising:
providing for first and second operational modes for a set of a plurality of user interface elements, the plurality of user interface elements in the set being associated with respective applications,
providing for displaying of the set of the plurality of user interface elements in the first operational mode such that limited contextual content is provided, the limited contextual content being associated with the respective applications and
providing for displaying of the set of the plurality of user interface elements in the second operational mode such that additional contextual content is provided, the additional contextual content being associated with the respective applications.

24. A computer program comprising code configured to:
provide for first and second operational modes for a set of a plurality of user interface elements, the plurality of user interface elements in the set being associated with respective applications, wherein
in the first operational mode, the set of the plurality of user interface elements is displayed such that limited contextual content is provided, the limited contextual content being associated with the respective applications and
in the second operational mode, the set of the plurality of user interface elements is displayed such that additional contextual content is provided, the additional contextual content being associated with the respective applications.
